(19) United States
(12) Patent Application Publication
(10) Pub. No.: US 2006/0088147 A1
(43) Pub. Date: Apr. 27, 2006

(54) Device and method for monitoring available calling plan minutes

(76) Inventor: Taeyoung Park, San Jose, CA (US)

Correspondence Address: TAEYOUNG PARK, 3379 ROYAL MEADOW LANE, SAN JOSE, CA, 95135, US

(21) Appl. No.: 10/972,687

(22) Filed: Oct. 25, 2004

(51) Int. Cl. H04M 15/00

(52) U.S. Cl. 379/130; 379/114.01

(57) ABSTRACT

A device and method for monitoring Available Calling Plan Minutes for use by a consumer with a calling plan is disclosed. The device and method include registers at different memory locations for storing data related to a calling plan and to Available Calling Plan Minutes. The device and method also includes a call timer to measure call duration based on call progress as determined by a data access arrangement circuit and a means to determine the call type. Further the device and method includes a means to renew the Available Calling Plan Minutes at the start of a new billing cycle. A display may also be provided to inform the consumer of the Available Calling Plan Minutes and to alert the consumer if the Calling Plan Minutes are exceeded.

### BACKGROUND OF THE INVENTION

I. Field of the Invention

The present invention relates to telephone monitoring devices and methods in general and to a device and method for monitoring available calling plan minutes in particular.

II. Description

In order to save money, many consumers sign up for a calling plan with a telephone company. The calling plan typically gives a consumer, for a fixed price, a fixed number of local, long distance, and/or international minutes per billing cycle (“Calling Plan Minutes”). The “Calling Plan Minutes” and the fixed price can vary from calling plan to calling plan. In general, the total time spent, on each telephone call, is deducted from the Calling Plan Minutes leaving the consumer with a number of minutes remaining in the billing cycle (“Available Calling Plan Minutes”) after each call. At the beginning of a new billing cycle, the Available Calling Plan Minutes are renewed with new Calling Plan Minutes and a new cycle begins. There is often a severe penalty when the Calling Plan Minutes are exceeded. The penalty involves being charged, in addition to the fixed price, additional fees at an increased cost per minute basis per call. The consumer often fails to keep track of their Calling Plan Minutes and has no indication of their Available Calling Plan Minutes in particular. This leaves the consumer either under utilizing their Calling Plan Minutes or exceeding their Calling Plan Minutes and paying additional fees.

It is currently difficult to track the Available Calling Plan Minutes in a specific calling plan. The time spent on every call needs to be manually subtracted from the Available Calling Plan Minutes or the consumer needs to contact the telephone company. In addition, the consumer would need to keep track of the billing cycle in order to renew the Available Calling Plan Minutes. This has led the consumer to use more minutes than the calling plan allows or has led the consumer to choose a calling plan with too many minutes and therefore waste money on Calling Plan Minutes that are never used.

There are many telephone monitoring devices and methods available today. The purpose of such prior art was to determine what charges will be incurred during a telephone call or to route a particular call through the least expensive carrier. With calling plans, however, the cost of a specific call or the cheapest route of a call is not necessarily important to the consumer. Since the consumer is paying a fixed price for the Calling Plan Minutes, the consumer is more interested in knowing what the Available Calling Plan Minutes are prior to and during each call. This information would allow the consumer to avoid exceeding the Calling Plan Minutes of the calling plan.

There are also devices and methods that accumulate the duration of every call as well as to the type of call being placed; local, long distance, international, etc. They inform the consumer of the total time or cost of telephone usage over a period of time per type of call. Once again, these devices and methods do not keep track of the Available Calling Plan Minutes. These devices and methods are often used in hotels and professional offices for billing purposes.

As can be determined, previous devices and methods do not address the need to monitor the Available Calling Plan Minutes nor do they address the requirement of calling plans, to renew the Available Calling Plan Minutes with new Calling Plan Minutes. The present invention provides a device and method for monitoring the Available Calling Plan Minutes per type of call in real time. This allows the consumer to adjust telephone usage for a particular billing cycle to avoid exceeding the Calling Plan Minutes and paying additional fees to the telephone company. This will also allow the consumer to adjust the calling plan to better suit their calling patterns. This will save the consumer money.

### SUMMARY OF THE INVENTION

The present invention is embodied in a device and method for monitoring Available Calling Plan Minutes in real time. It is an object of the device and method to monitor and inform the consumer of the Available Calling Plan Minutes based on a call type; local, long distance, international, etc., and to alert the consumer when the Calling Plan Minutes are exceeded. It is a further object of this device and method to inform the consumer of the number of minutes, from their Calling Plan Minutes, they have exceeded if any. It is still a further object of this device and method to inform the consumer of past minutes that have been under or over their Calling Plan Minutes.

The device and method includes a means to determine the Available Calling Plan Minutes and a means to renew the Available Calling Plan Minutes with the Calling Plan Minutes at the beginning of a new billing cycle. Further, this device and method includes a means of determining call time responsive to a call progress signal. The device and method also includes a means for determining call type; local, long distance, international, etc.

Said means to determine Available Calling Plan Minutes are coupled to a means to inform the consumer and a means to alert the consumer when their Calling Plan Minutes are exceeded.

The device and method includes a programming means to set a date, set billing cycle dates and set the Calling Plan Minutes.

Finally the device and method includes a power means to adequately power the various functions described herein.

### BRIEF DESCRIPTION OF THE DRAWINGS

The present invention will now be described, by way of example, with reference to the accompanying drawings, in which:

FIG. 1 illustrates a calling plan monitoring device that connects to a telephone and a telephone line.

FIG. 2 is a functional block diagram of a calling plan monitoring device designed in accordance with the principles of this invention.

FIG. 3 is a flow chart illustrating the operational process of the calling plan monitoring device shown in FIG. 2.

### DETAILED DESCRIPTION OF THE PREFERRED EMBODIMENT

The device and method to monitor the Available Calling Plan Minutes, for use by a consumer with a calling plan, is herein described.

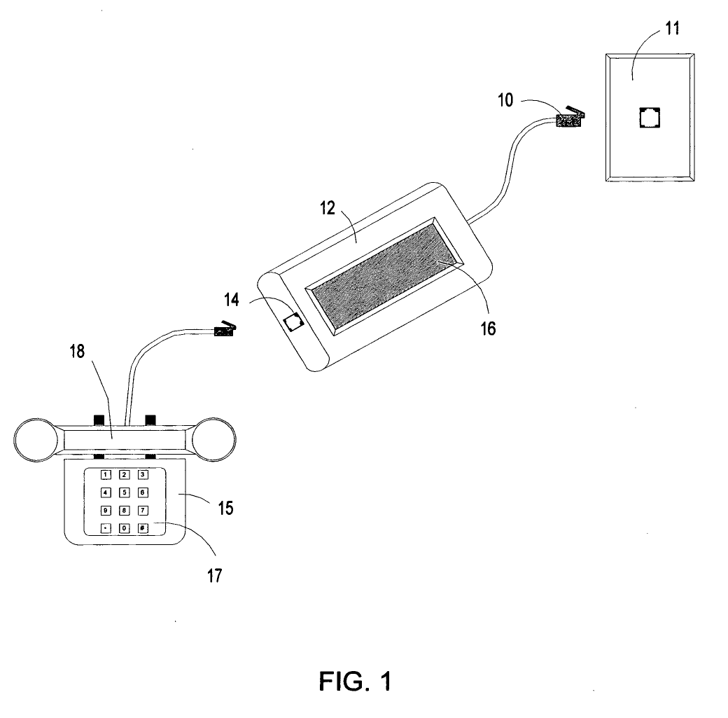

FIG. 1 shows a calling plan monitoring device (12) that includes an enclosure with a display area (16), a connection means (14) to a telephone (15) and a connection means (10) to a standard telephone line wall jack (11) in accordance with this invention. It should be noted that any suitable type of housing which encloses the indicated electronic components may be used as known by those skilled in the art. Also the calling plan monitoring device (12) does not need to be a separate unit from the telephone (15). It can be known by those skilled in the art to integrate the calling plan monitoring device (12) and method into any telephone.

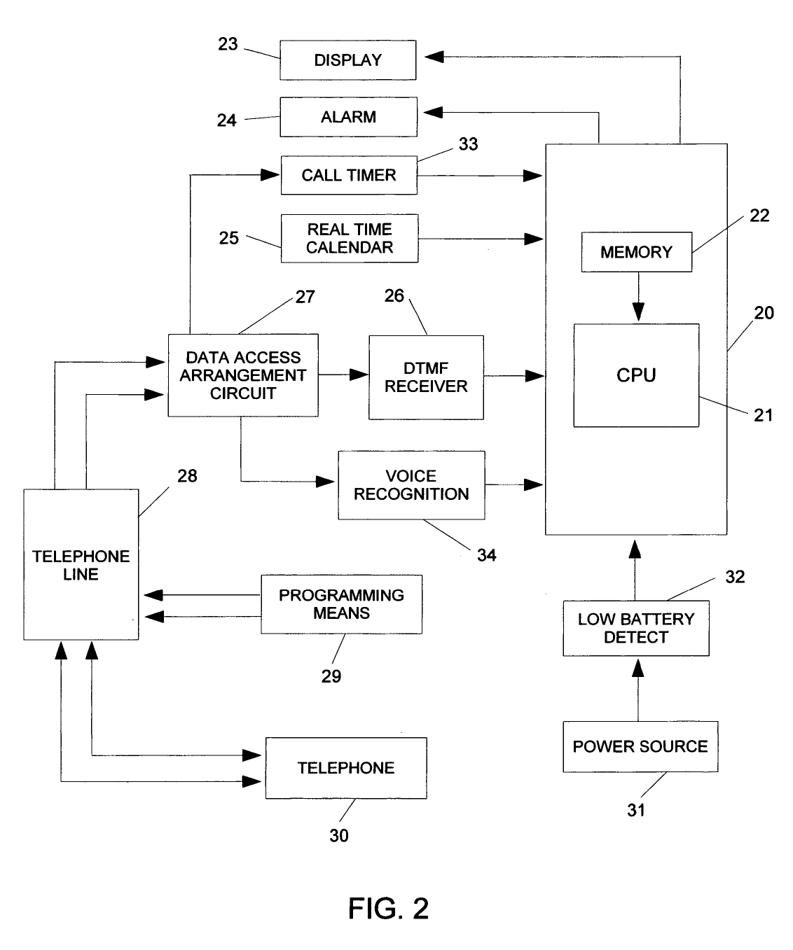

The calling plan monitoring device (12) and method is represented by the functional block diagram in FIG. 2. It includes a microcontroller (20) which includes a CPU (21) and memory (22), which may include read-only memory, random access memory, non-volatile memory or a combination thereof. The memory (22) includes a number of specific memory registers to hold various Available Calling Plan Minutes values per said call type. These registers can be implemented at different memory locations comprising some or all of the following registers; an available local register, an available long distance register, an available international register, and/or any other call type registers specific to the calling plan. In addition, the memory (22) includes a number of specific memory registers to hold various Calling Plan Minutes values per said call type. These registers can be implemented at different memory locations comprising some or all of the following registers; a local calling plan minutes register, a long distance calling plan minutes register, an international calling plan minutes register, and/or any other call type registers specific to the calling plan. The consumer, through a programming means (29), which will be discussed later, sets said local calling plan minutes register, long distance calling plan minutes register, international calling plan minutes register with the Calling Plan Minutes called for in the calling plan. Further the memory (22) includes a specific memory location to hold a billing cycle date register. The consumer, through said programming means (29), sets said billing cycle date register with the date when the billing cycle begins and/or ends.

Also included in the calling plan monitoring device (12) is a data access arrangement circuit (27) which provides an interface to a telephone (30) and to a telephone line (28). The data access arrangement circuit (27) also provides information on the status of a telephone (30) and the telephone line (28) such as, but not limited to, telephone (30) hook switch condition, telephone (30) ring detection, telephone line (28) loop current, telephone line (28) voltage and other telephone (30) and telephone line (28) call progress parameters. Those skilled in the art recognize that many known data access arrangement circuits are suitable for data access arrangement circuit (27). Therefore, a detailed description will not be undertaken herein.

Further the calling plan monitoring device (12) also includes a means to determine billing cycle. In one embodiment said means includes a real time calendar generator (25) that when requested by the CPU (21) provides a current date. The current date, provided by the real time calendar generator (25) to the CPU (21), is compared to the date in the billing cycle date register. If the date matches, a new billing cycle has begun.

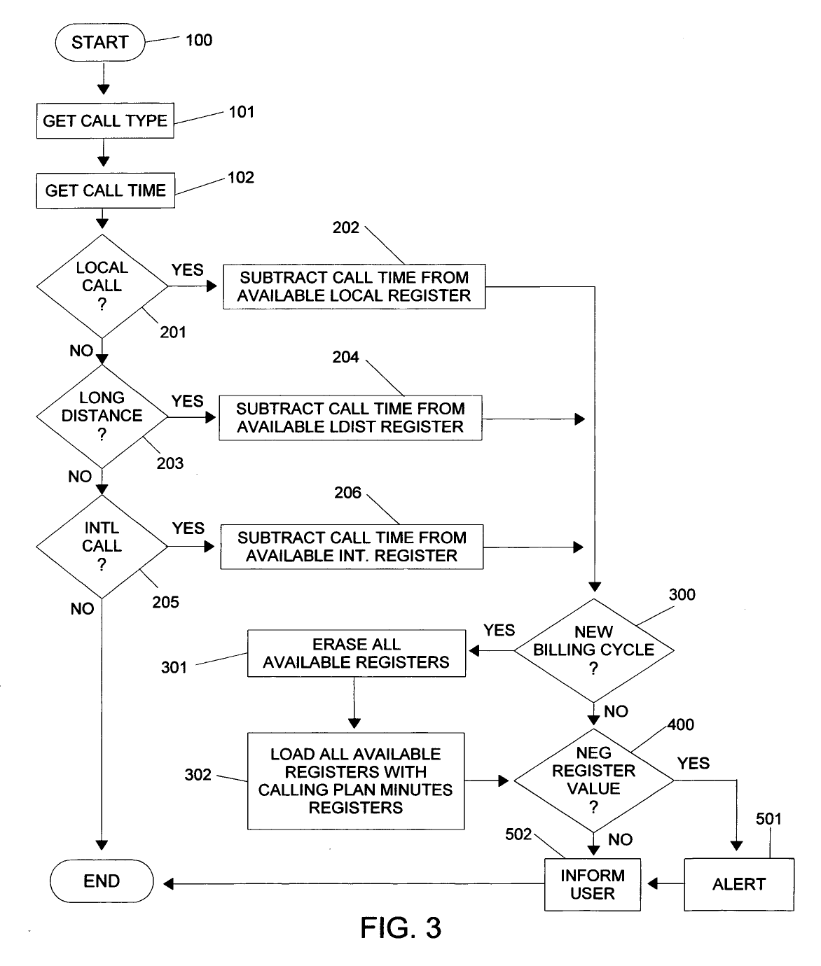

A flowchart of the operational process of the device and method to monitor the Available Calling Plan Minutes is illustrated in FIG. 3. At the start (100), a call is initiated by the consumer. In step (101), the CPU (21) determines said call type by a means to determine call type. In one embodiment, said means includes a dual tone multi-frequency (“DTMF”) receiver (26) which decodes a DTMF signal from a telephone keypad (17) into binary data for the CPU (21). The binary data represents a telephone number dialed by the consumer and is used to determine said call type being made; any seven digits would indicate a local call, a digit “1” followed by 10 digits would indicate a long distance call, digits “011” would precede any international call and so forth. It is also known by those skilled in the art that the DTMF receiver function could be part of the microcontroller (20) or be implemented in software. In another embodiment, the binary data could be read directly from the telephone keypad (17). In still another embodiment, a voice recognition means (34) could be used to determine said call type. The consumer would speak a command, through a telephone handset (18) or a microphone, such as; “local”, “long distance”, “international”, prior to dialing a phone number, to let the CPU (21) know said call type. In still another embodiment, the CPU (21) would store a telephone exchange and a corresponding call type in memory (22). Any dialed number could then be compared to the telephone exchange to determine said call type. This is especially useful for those local exchanges that are considered local toll numbers and where the minutes of dialed local exchange are deducted from the local minutes on the calling plan. The local exchanges could also be programmed into memory (22) by the programming means (29).

In step (102), the CPU (21) determines a call time by a means to determine call time. Said means to determine call time includes a means for determining call progress and a means for measuring time. In one embodiment, said means for determining call progress is provided by the data access arrangement circuit (27). The data access arrangement circuit (27) can provide, to a call timer (33), a connection signal at the beginning of a call and a termination signal at the end of a call. The connection signal can be generated by the data access arrangement circuit (27) for example when the telephone line (28) loop current is detected. The termination signal can be generated when the data access arrangement circuit (27) determines that the telephone (30) hook switch is in the “on” position. The call timer (33) initiated by the connection signal generated by said means for determining call progress and terminated by a corresponding termination signal by said means for determining call progress, measures the call time. Those having skill in the art will recognize that many call timers, both hardware and software in design, are suitable to determine the call time. Therefore, a detailed description of the particular selection, implementation and operation of the call timer (33) and the use thereof to measure said call time will not be undertaken herein.

In step (201), the CPU (21) determines whether a local call was originated in step (101). If the result of the determination in step (201) is YES, the CPU (21) in step (202) subtracts the call timer (33) value as determined in step (102) from the current value in said available local register and saves the result in said available local register. Thus said available local register would hold a value equal to the Available Calling Plan Minutes for local calls. If the result in determination (201) is NO, the CPU (21) in step (203) determines whether a long distance call was originated in step (101). If the result of the determination in step (203) is YES, the CPU (21) in step (204) subtracts the call timer (33) value as determined in step (102) from the current value in said available long distance register and saves the result in said available long distance register. Thus said available long distance register would hold a value equal to the Available Calling Plan Minutes for long distance calls. If the result in determination (203) is NO, the CPU (21) in step (205) determines whether an international call was originated in step (101). If the result of the determination in step (205) is YES, the CPU (21) in step (206) subtracts the call timer (33) value as determined in step (102) from the current value in said available international register and saves the result in said available international register. Thus said available international register would hold a value equal to the Available Calling Plan Minutes for international calls. If the result in determination (205) is NO, the operational process is ended.

It can be appreciated by those skilled in the art that additional determination steps accounting for other specific call types could be added. It can be further appreciated by those skilled in the art that steps (201), (203), and/or (205) could be combined into one or more steps. For example, a determination could be made whether a long distance call or an international call was originated in step (101). If the result of the determination is YES, the call timer (33) value as determined in step (102) would be subtracted from a commonly shared available register and the result would be saved in said commonly shared available register. This would accommodate calling plans that do not distinguish between certain call types and have one shared Calling Plan Minutes. It can be still further appreciated by those skilled in the art that steps (202), (204), and/or (206) could be skipped altogether if the calling plan allows for unlimited minutes for a particular call type. It can be still further appreciated by those skilled in the art that said available local register, available long distance register, available international register, and/or commonly shared available register can be counted down on a per second or per minute basis while the call is in progress. This would provide the consumer the Available Calling Plan Minutes in real time. All the above are within the scope of the present invention.

After steps (202), (204), or (206), the CPU (21) in step (300), determines by said means to determine billing cycle whether a new billing cycle has begun. If the result of the determination in step (300) is YES, said available local register, available long distance register, and/or available international register, are erased in step (301). It can be appreciated that prior to erasure the data in said available local register, available long distance register, and/or available international register are saved along with a corresponding billing cycle date into memory (22) for later retrieval. In step (302), said available local register, available long distance register, and/or available international register are loaded with the values from said local calling plan minutes register, long distance calling plan minutes register, and/or international calling plan minutes register respectively. Thus said available local register, available long distance register, and/or available international register would be renewed with the Calling Plan Minutes called for in the calling plan. The operational process proceeds to step (400). If the determination in step (300) is NO, the operational process immediately proceeds to step (400).

In step (400) the CPU (21) determines whether said available local register, available long distance register, and/or available international register, as determined in steps (202), (204), (206) contains a negative value. The negative value would represent the minutes exceeding the Calling Plan Minutes. If the result of the determination in step (400) is YES the CPU (21) activates said means to alert in step (501). Said means to alert can comprise of an audible alarm, a visual alarm (24), or a combination. In one embodiment said means to alert could be specific to said call type that is exceeding the Calling Plan Minutes. The operational process proceeds to step (502). If the result in determination (400) is NO, the operational process immediately proceeds to step (502).

In step (502), the CPU (21) by said means to inform the consumer, informs the consumer of the Available Calling Plan Minutes. In one embodiment, said available local register, available long distance register, and/or available international register, as determined in steps (202), (204), (206) are subsequently coupled to a display (23) means to inform the consumer of the Available Calling Plan Minutes or the number of minutes exceeding the Calling Plan Minutes based on said call type. Said display means can include a liquid crystal display (LCD), a LED display, or other visual type of indicator. In another embodiment said available local register, available long distance register, and/or available international register, as determined in steps (202), (204), (206) are output to a voice synthesizer. The voice synthesizer could inform the consumer through a speaker or through the telephone (30) ear piece. Once the consumer is informed, the operational process is ended. It can be appreciated by those skilled in the art that when said available local register, available long distance register, and/or available international register in step (202), (204), or (206) is being counted down on a per second or per minute basis the operational process would end, when the CPU (21) receives a termination signal by said means for determining call progress.

The calling plan monitoring device (12) includes said programming means (29) that attaches to the telephone line (28). However, it can be appreciated that a separate connector could also be used. The current date as well as dates for the billing cycle is set by said programming means (29). In addition, the Calling Plan Minutes pursuant to the calling plan is loaded into said local calling plan minutes register, long distance calling plan minutes register, and/or international calling plan register by said programming means (29). In one embodiment, said programming means (29) is an external keypad capable of generating DTMF signals. In another embodiment said programming means (29) is a computer. In still another embodiment, said programming means (29) is provided by the telephone keypad (17). In yet another embodiment, said programming means (29) is provided by voice recognition means (34) through the telephone handset (18).

The calling plan monitoring device (12) includes a power source (31) to provide power to all the functional elements described. Typically it would be an external power unit sufficient enough to power the calling plan monitoring device (12). In one embodiment, the power source (31) would be a battery, monitored by a low battery detect circuit (32). When triggered, the CPU (21) would activate a low battery warning using the visual alarm (24). In another embodiment, the power source (31) could be the telephone lines (28). Telephone companies generate enough sufficient power on the telephone lines (28) to power the calling plan monitoring device (12). The calling plan monitoring device (12) may optionally include a means for turning the unit on and off. Those skilled in the art recognize that any known power source sufficient to power the functional elements of this device is suitable for power source (31). Therefore, a detailed description will not be undertaken herein.

What is claimed is:

1. A device for monitoring Available Calling Plan Minutes comprising:
a means for determining Available Calling Plan Minutes;
a means for renewing Calling Plan Minutes every billing cycle;
a means to inform a consumer of the Available Calling Plan Minutes.

2. The device as recited in claim 1, wherein the means for determining Available Calling Plan Minutes includes:
(a) a means for determining call type;
(b) a means for measuring call time;
(c) a means for subtracting the value of said means for measuring call time from a present value of a memory register specific to a call type as determined by said means for determining call type.

3. The device as recited in claim 2, wherein the means for determining call type is a dual tone multi frequency signal.

4. The device as recited in claim 2, wherein the means for determining call type is a telephone keypad.

5. The device as recited in claim 2, wherein the means for determining call type is a voice recognition means.

6. The device as recited in claim 2, wherein the means for determining call type is a memory register wherein telephone exchanges and corresponding call types are stored and can be compared with a dialed number.

7. The device as recited in claim 2, wherein said means for determining call time includes:
(a) a means for determining call progress;
(b) a means for measuring time initiated by a connection signal generated by said means for determining call progress and terminated by a termination signal generated by said means for determining call progress.

8. The device as recited in claim 7, wherein said means for determining call progress is by the status of the telephone hook switch.

9. The device as recited in claim 7, wherein said means for determining call progress is by the detection of the telephone ring status.

10. The device as recited in claim 7 wherein said means for determining call progress is by the status of the telephone lines loop current.

11. The device as recited in claim 7 wherein said means for determining call progress is by the status of the telephone lines voltage.

12. The device as recited in claim 7 wherein said means for determining call progress is by the detection of the presence of a voice signal.

13. The device as recited in claim 7, wherein the means for measuring call time is a real time clock.

14. The device as recited in claim 1, wherein the means for renewing the Calling Plan Minutes every billing cycle includes:
(a) a means to determine billing cycle date;
(b) a means to determine current date;
(c) a means for storing Calling Plan Minutes as called for in a calling plan;
(d) a means for loading the value of said means for storing the Calling Plan Minutes as called for in the calling plan into a memory register specific to a call type when the billing cycle as determined by said means to determine billing cycle matches the current date as determined by said means to determine current date.

15. The device as recited in claim 14 wherein the means to determine billing cycle date is a memory register wherein the billing cycle date is stored and can be compared to the current date as determined by said means for determining the current date.

16. The device as recited in claim 14, wherein the means to determine current date is a real time calendar.

17. The device as recited in claim 14, wherein the means for storing the Calling Plan Minutes as called for in the calling plan are memory registers specific to the call type.

18. The device as recited in claim 1, wherein the means to inform the consumer is a display.

19. The device as recited in claim 1, wherein the means to inform the consumer is by audio communication.

20. The device as recited in claim 1, wherein the device further comprises a means to alert the consumer when the Available Calling Plan Minutes exceeds the calling plan minutes.

21. The device as recited in claim 1, wherein the device further comprises a power source.

22. The device as recited in claim 21, wherein the power source is the telephone lines.

23. The device as recited in claim 21, wherein the power source is a battery.

24. A method for monitoring Available Calling Plan Minutes comprising the steps of:
(a) determining available Calling Plan Minutes;
(b) renewing Calling Plan Minutes every billing cycle;
(c) informing a consumer of the Available Calling Plan Minutes.

25. The method of claim 24 wherein said method of determining Available Calling Plan minutes includes steps comprising of:
(a) determining call type;
(b) measuring call time;
(c) subtracting the value of said call time from the present value of a memory register specific to a call type.

26. The method of claim 24 wherein said method of renewing Calling Plan Minutes every billing cycle includes steps comprising of:
(a) determining a billing cycle date;
(b) determining a current date;
(c) storing Calling Plan Minutes as called for in a calling plan;
(d) restoring the Calling Plan Minutes as called for in the calling plan;
(e) loading the value of the Calling Plan Minutes as called for in the calling plan into a memory register specific to a call type when the billing cycle date matches the current date.
